(19) United States
(12) Patent Application Publication
(10) Pub. No.: US 2018/0198654 A1
(43) Pub. Date: Jul. 12, 2018

(54) Signaling of Training Field Length and Guard Interval Duration

(71) Applicant: Marvell World Trade Ltd., St. Michael (BB)

(72) Inventors: Hongyuan ZHANG, Fremont, CA (US); Sudhir SRINIVASA, Campbell, CA (US); Yan ZHANG, Palo Alto, CA (US); Rui CAO, Fremont, CA (US)

(21) Appl. No.: 15/867,067

(22) Filed: Jan. 10, 2018

Related U.S. Application Data
(60) Provisional application No. 62/470,055, filed on Mar. 10, 2017.
(60) Provisional application No. 62/444,510, filed on Jan. 10, 2017.

(51) Int. Cl. H04L 27/26; H04L 29/08

(52) U.S. Cl. CPC H04L 27/2605; H04L 69/324

(57) ABSTRACT

When a communication device determines that a packet (PPDU) is to use a first length of a training field and a first duration of a guard interval (GI), the communication device generates a field of the PHY preamble to include a subfield set to a first value that indicates the packet uses the first length of the training field and the first duration of the GI. When the communication device determines that the PPDU is to use the first length of the training field and a second duration of the GI the communication device generates the field of the PHY preamble to include i) the subfield set to the first value, ii) one or more other subfields set to one or more second values that correspond to a mode that is not permitted by a communication protocol, to indicate that the PPDU uses the first length of the training field and the second duration of the GI.

### CROSS REFERENCES TO RELATED APPLICATIONS

This application claims the benefit of U.S. Provisional Patent Application No. 62/444,510, entitled “New combination of HELTF size and GI duration for Beamforming scenarios in IEEE802.11ax,” filed on Jan. 10, 2017, and U.S. Provisional Patent Application No. 62/470,055, entitled “Signaling of HELTF-4× and 0.8 us Guard Interval (GI) Duration for Beamforming Transmissions in IEEE802.11ax,” filed on Mar. 10, 2017. The disclosures of the applications referenced above are hereby incorporated herein by reference in their entireties.

### FIELD OF TECHNOLOGY

The present disclosure relates generally to wireless communication systems, and more particularly to physical layer (PHY) protocol data unit formats.

### BACKGROUND

Wireless local area networks (WLANs) have evolved rapidly over the past decade, and development of WLAN standards such as the Institute for Electrical and Electronics Engineers (IEEE) 802.11 Standard family has improved single-user peak data throughput. For example, the IEEE 802.11b Standard specifies a single-user peak throughput of 11 megabits per second (Mbps), the IEEE 802.11a and 802.11g Standards specify a single-user peak throughput of 54 Mbps, the IEEE 802.11n Standard specifies a single-user peak throughput of 600 Mbps, and the IEEE 802.11ac Standard specifies a single-user peak throughput in the gigabits per second (Gbps) range. Future standards promise to provide even greater throughput, such as throughputs in the tens of Gbps range.

### SUMMARY

In an embodiment, a method is for generating a physical layer (PHY) protocol data unit (PPDU) according to a communication protocol that specifies a plurality of allowed lengths of a training field in a PHY preamble of the PPDU, and a plurality of allowed durations of a guard interval (GI) corresponding to a spacing between transmission symbols in the PPDU. The method includes: when a communication device determines that the PPDU is to use a first length of the training field and a first duration of the GI, generating, at the communication device, a field of the PHY preamble to include a subfield set to a first value, the first value indicating that the PPDU uses the first length of the training field and the first duration of the GI; and when the communication device determines that the PPDU is to use the first length of the training field and a second duration of the GI, generating, at the communication device, the field of the PHY preamble to include the subfield set to the first value, and generating, at the communication device, the field of the PHY preamble to include one or more other subfields set to one or more second values that correspond to a PHY mode that is not permitted by the communication protocol, wherein the subfield set to the first value and the one or more other subfields set to the one or more second values indicate that the PPDU uses the first length of the training field and the second duration of the GI. The method also includes generating, at the communication device, the PPDU, including: generating the PHY preamble to include one or more training fields, each training field having the first length, and generating a data portion of the PHY data unit wherein if the communication device determined that the PPDU is to use the first duration of the GI, including GIs of the first duration between transmission symbols of i) the one or more training fields each having the first length and ii) the data portion, and if the communication device determined that the PPDU is to use the second duration of the GI, including GIs of the second duration between transmission symbols of i) the one or more training fields each having the first length and ii) the data portion.

In another embodiment, an apparatus comprises a network interface device associated with a first communication device, wherein the network interface device includes one or more integrated circuits (ICs). The one or more ICs are configured to: generate a physical layer (PHY) protocol data unit (PPDU) according to a communication protocol that specifies a plurality of allowed lengths of a training field in a PHY preamble of the PPDU, and a plurality of allowed durations of a guard interval (GI) corresponding to a spacing between transmission symbols in the PPDU, including: when the network interface device determines that the PPDU is to use a first length of the training field and a first duration of the GI, generating a field of the PHY preamble to include a subfield set to a first value, the first value indicating that the PPDU uses the first length of the training field and the first duration of the GI. The one or more ICs are further configured to: when the network interface device determines that the PPDU is to use the first length of the training field and a second duration of the GI, generate the field of the PHY preamble to include the subfield set to the first value, and generate the field of the PHY preamble to include one or more other subfields set to one or more second values that correspond to a PHY mode that is not permitted by the communication protocol, wherein the subfield set to the first value and the one or more other subfields set to the one or more second values indicate that the PPDU uses the first length of the training field and the second duration of the GI. The one or more ICs are further configured to: generate the PHY preamble to include one or more training fields, each training field having the first length, and generate a data portion of the PHY data unit, wherein if the network interface device determined that the PPDU is to use the first duration of the GI, including GIs of the first duration between transmission symbols of i) the one or more training fields each having the first length and ii) the data portion, and if the network interface device determined that the PPDU is to use the second duration of the GI, including GIs of the second duration between transmission symbols of i) the one or more training fields each having the first length and ii) the data portion.

In yet another embodiment, a method is for processing a physical layer (PHY) protocol data unit (PPDU) received via a communication channel, the PPDU formatted according to a communication protocol that specifies a plurality of allowed lengths of a training field in a PHY preamble of the PPDU, and a plurality of allowed durations of a guard interval (GI) corresponding to a spacing between transmission symbols in the PPDU. The method includes: determining, at a communication device, that a subfield in a field of a PHY preamble of the PPDU is set to a first value, wherein the subfield is for indicating i) a length of each of one or more training fields in the PHY preamble, and ii) a duration of GIs for the PPDU; determining, at the communication device, the length of each of one or more training fields in the PHY preamble according to the first value of the subfield; determining, at the communication device, whether one or more other subfields in the field of the PHY preamble are set to one or more second values that correspond to a PHY mode that is not permitted by the communication protocol; when the communication device determines that i) the subfield is set to the first value, and ii) the one or more other subfields in the field of the PHY preamble are set to one or more second values that correspond to a PHY mode that is permitted by the communication protocol, determining, at the communication device, that the PPDU uses GIs of the first duration between transmission symbols; when the communication device determines that i) the subfield is set to the first value, and ii) the one or more other subfields in the field of the PHY preamble are set to one or more second values that correspond to the PHY mode that is not permitted by the communication protocol, determining, at the communication device, that the PPDU uses GIs of the second duration between transmission symbols; processing, at the communication device, the one or more training fields in the PHY preamble according to the determined length of each of the one or more training fields; and processing, at the communication device, a data portion of the PPDU according to the determined duration of the GIs.

In still another embodiment, an apparatus, comprises a network interface device associated with a first communication device, wherein the network interface device includes one or more integrated circuits (ICs). The one or more ICs are configured to: process a physical layer (PHY) protocol data unit (PPDU) received via a communication channel, the PPDU formatted according to a communication protocol that specifies a plurality of allowed lengths of a training field in a PHY preamble of the PPDU, and a plurality of allowed durations of a guard interval (GI) corresponding to a spacing between transmission symbols in the PPDU, including: determining that a subfield in a field of a PHY preamble of the PPDU is set to a first value, wherein the subfield is for indicating i) a length of each of one or more training fields in the PHY preamble, and ii) a duration of GIs for the PPDU, determining the length of each of one or more training fields in the PHY preamble according to the first value of the subfield, and determining whether one or more other subfields in the field of the PHY preamble are set to one or more second values that correspond to a PHY mode that is not permitted by the communication protocol. The one or more ICs are further configured to: when the network interface device determines that i) the subfield is set to the first value, and ii) the one or more other subfields in the field of the PHY preamble are set to one or more second values that correspond to a PHY mode that is permitted by the communication protocol, determining that the PPDU uses GIs of the first duration between transmission symbols; and when the network interface device determines that i) the subfield is set to the first value, and ii) the one or more other subfields in the field of the PHY preamble are set to one or more second values that correspond to the PHY mode that is not permitted by the communication protocol, determining that the PPDU uses GIs of the second duration between transmission symbols. The one or more ICs are further configured to: process the one or more training fields in the PHY preamble according to the determined length of each of the one or more training fields; and process a data portion of the PPDU according to the determined duration of the GIs.

### BRIEF DESCRIPTION OF THE DRAWINGS

FIG. 1 is a block diagram of an example wireless local area network (WLANs), according to an embodiment.

FIG. 2A is a block diagram of an example single-user physical layer (PHY) protocol data unit (PPDU), according to an embodiment.

FIG. 2B is a block diagram of an example multi-user PPDU, according to an embodiment.

FIG. 3A is a block diagram of an example signal field used in the single-user PPDU of FIG. 2A, according to an embodiment.

FIG. 3B is a block diagram of an example signal field used in the multi-user PPDU of FIG. 2B, according to an embodiment.

FIG. 4 is a flow diagram of an example method for generating a PPDU, according to an embodiment.

FIG. 5 is a flow diagram of an example method of processing a PPDU received via a communication channel, according to an embodiment.

### DETAILED DESCRIPTION

Communication systems often employ guard intervals (GIs) between adjacent transmission symbols (e.g., orthogonal frequency division multiplexing (OFDM) symbols) to reduce inter-symbol interference (ISI), for example. ISI generally increases with longer range transmissions. Generally, a longer GI duration decreases ISI, but reduces the data rate. A communication protocol defines multiple allowable GI durations so that in poor channel conditions and/or longer range communications, a longer GI can be used, whereas in better channel conditions and/or for shorter range communications, a shorter GI duration can be used, at least in some embodiments.

Training field(s) in a physical layer (PHY) protocol preamble of a PHY protocol data unit (PPDU) are used by a receiver to calculate a channel estimate for purposes of equalization, beamforming, etc., for example. Generally, a longer training field facilitates generating a more accurate channel estimate (especially for longer range communications with longer delay spread), but increases overhead (e.g., more medium time is devoted to transmission of training signals rather than data). The communication protocol defines multiple allowable training field lengths so that in poor channel conditions and/or longer range communications, a longer training field size can be used, whereas in better channel conditions and/or for shorter range communications, a shorter training field size can be used, at least in some embodiments.

Embodiments of techniques for signaling to a receiving device a particular GI duration and a particular training field size used for a PPDU are described below.

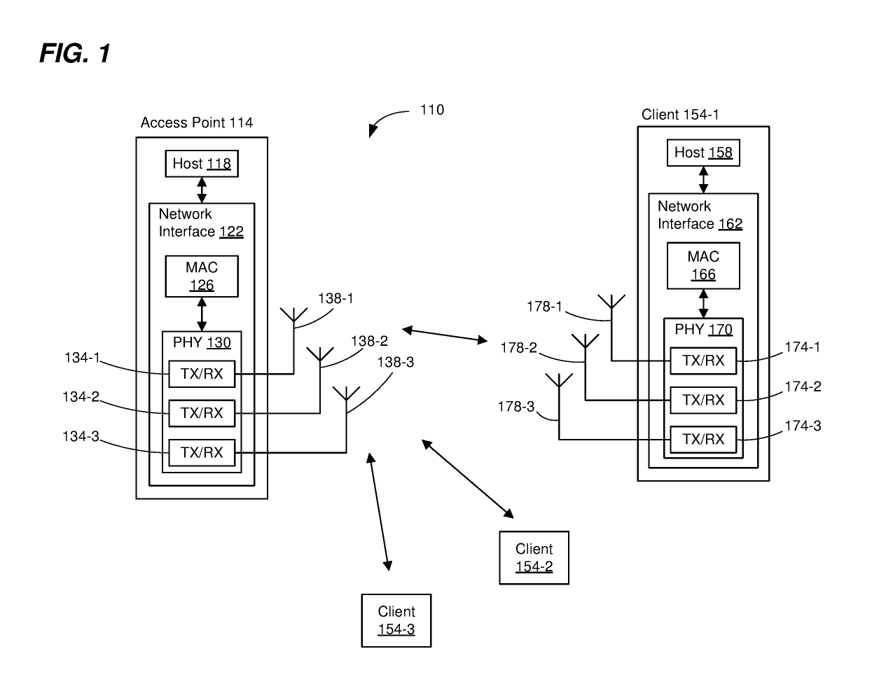

FIG. 1 is a block diagram of an example WLAN 110, according to an embodiment. The WLAN 110 includes an access point (AP) 114 that comprises a host processor 118 coupled to a network interface device 122. The network interface 122 includes a medium access control (MAC) processor 126 and a PHY processor 130. The PHY processor 130 includes a plurality of transceivers 134, and the transceivers 134 are coupled to a plurality of antennas 138. Although three transceivers 134 and three antennas 138 are illustrated in FIG. 1, the AP 114 includes other suitable numbers (e.g., 1, 2, 4, 5, etc.) of transceivers 134 and antennas 138 in other embodiments. In some embodiments, the AP 114 includes a higher number of antennas 138 than transceivers 134, and antenna switching techniques are utilized.

The network interface 122 is implemented using one or more integrate circuits (ICs) configured to operate as discussed below. For example, the MAC processor 126 may be implemented, at least partially, on a first IC, and the PHY processor 130 may be implemented, at least partially, on a second IC. As another example, at least a portion of the MAC processor 126 and at least a portion of the PHY processor 130 may be implemented on a single IC. For instance, the network interface 122 may be implemented using a system on a chip (SoC), where the SoC includes at least a portion of the MAC processor 126 and at least a portion of the PHY processor 130.

In various embodiments, the MAC processor 126 and/or the PHY processor 130 of the AP 114 are configured to generate data units, and process received data units, that conform to a WLAN communication protocol such as a communication protocol conforming to the IEEE 802.11 Standard or another suitable wireless communication protocol. For example, the MAC processor 126 may be configured to implement MAC layer functions, including MAC layer functions of the WLAN communication protocol, and the PHY processor 130 may be configured to implement PHY functions, including PHY functions of the WLAN communication protocol. For instance, the MAC processor 126 may be configured to generate MAC layer data units such as MAC service data units (MSDUs), MAC protocol data units (MPDUs), etc., and provide the MAC layer data units to the PHY processor 130. The PHY processor 130 may be configured to receive MAC layer data units from the MAC processor 126 and encapsulate the MAC layer data units to generate PHY data units such as PPDUs for transmission via the antennas 138. Similarly, the PHY processor 130 may be configured to receive PHY data units that were received via the antennas 138, and extract MAC layer data units encapsulated within the PHY data units. The PHY processor 130 may provide the extracted MAC layer data units to the MAC processor 126, which processes the MAC layer data units.

In some embodiments, the PHY processor 130 is configured to select a particular GI duration and a particular training field size to be used in a PPDU, and then generate a signal field of a PHY preamble of the PPDU to include information that indicates the particular GI duration and a particular training field size used in the PPDU. The information in the PHY preamble signals to a receiving device which GI duration and which training field size were used so that the receiving device can properly process the PPDU. In some embodiments, when the AP 114 receives a PPDU transmitted by another communication device, the PHY processor 130 examines information in a PHY preamble of the PPDU to determine which GI duration and which training field size were used so that the PHY processor 130 can properly process the PPDU.

The WLAN 110 includes a plurality of client stations 154. Although three client stations 154 are illustrated in FIG. 1, the WLAN 110 includes other suitable numbers (e.g., 1, 2, 4, 5, 6, etc.) of client stations 154 in various embodiments. The client station 154-1 includes a host processor 158 coupled to a network interface device 162. The network interface 162 includes a MAC processor 166 and a PHY processor 170. The PHY processor 170 includes a plurality of transceivers 174, and the transceivers 174 are coupled to a plurality of antennas 178. Although three transceivers 174 and three antennas 178 are illustrated in FIG. 1, the client station 154-1 includes other suitable numbers (e.g., 1, 2, 4, 5, etc.) of transceivers 174 and antennas 178 in other embodiments. In some embodiments, the client station 154-1 includes a higher number of antennas 178 than transceivers 174, and antenna switching techniques are utilized.

The network interface 162 is implemented using one or more ICs configured to operate as discussed below. For example, the MAC processor 166 may be implemented on at least a first IC, and the PHY processor 170 may be implemented on at least a second IC. As another example, at least a portion of the MAC processor 166 and at least a portion of the PHY processor 170 may be implemented on a single IC. For instance, the network interface 162 may be implemented using an SoC, where the SoC includes at least a portion of the MAC processor 166 and at least a portion of the PHY processor 170.

In various embodiments, the MAC processor 166 and the PHY processor 170 of the client device 154-1 are configured to generate data units, and process received data units, that conform to the WLAN communication protocol or another suitable communication protocol. For example, the MAC processor 166 may be configured to implement MAC layer functions, including MAC layer functions of the WLAN communication protocol, and the PHY processor 170 may be configured to implement PHY functions, including PHY functions of the WLAN communication protocol. The MAC processor 166 may be configured to generate MAC layer data units such as MSDUs, MPDUs, etc., and provide the MAC layer data units to the PHY processor 170. The PHY processor 170 may be configured to receive MAC layer data units from the MAC processor 166 and encapsulate the MAC layer data units to generate PHY data units such as PPDUs for transmission via the antennas 178. Similarly, the PHY processor 170 may be configured to receive PHY data units that were received via the antennas 178, and extract MAC layer data units encapsulated within the PHY data units. The PHY processor 170 may provide the extracted MAC layer data units to the MAC processor 166, which processes the MAC layer data units.

In some embodiments, the PHY processor 170 is configured to select a particular GI duration and a particular training field size to be used in a PPDU, and then generate a signal field of a PHY preamble of the PPDU to include information that indicates the particular GI duration and a particular training field size used in the PPDU. The information in the PHY preamble signals to a receiving device which GI duration and which training field size were used so that the receiving device can properly process the PPDU. In some embodiments, when the client station 154-1 receives a PPDU transmitted by another communication device, the PHY processor 170 examines information in a PHY preamble of the PPDU to determine which GI duration and which training field size were used so that the PHY processor 170 can properly process the PPDU.

In an embodiment, each of the client stations 154-2 and 154-3 has a structure that is the same as or similar to the client station 154-1. Each of the client stations 154-2 and 154-3 has the same or a different number of transceivers and antennas. For example, the client station 154-2 and/or the client station 154-3 each have only two transceivers and two antennas (not shown), according to an embodiment.

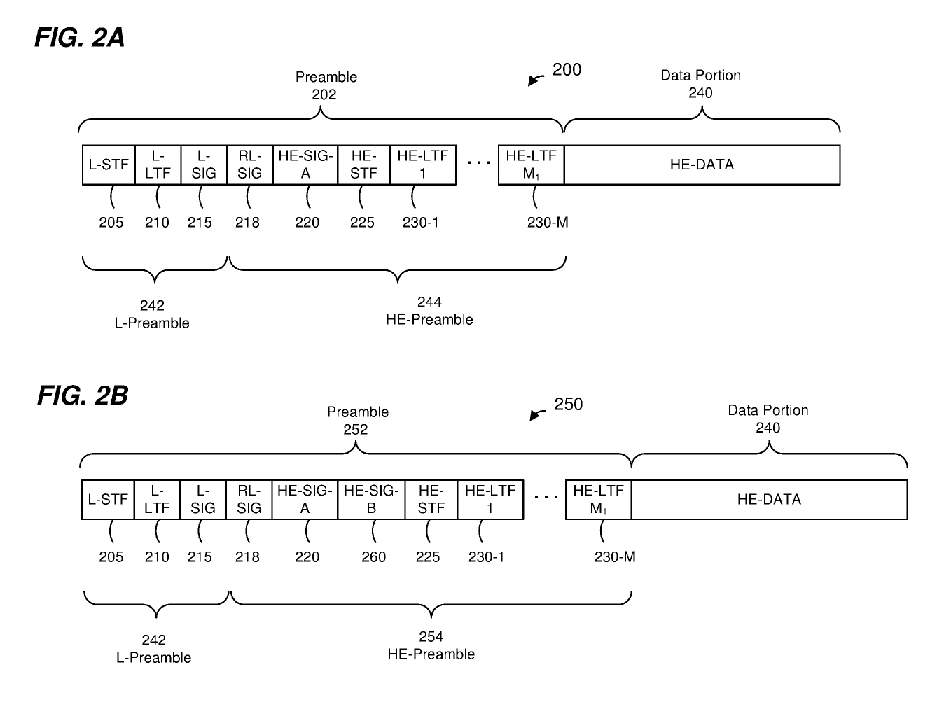

FIG. 2A is a diagram of a single-user physical layer (PHY) protocol data unit (PPDU) 200 that the network interface 122 (FIG. 1) is configured to generate and transmit to one client station 154 (e.g., the client station 154-1), according to an embodiment. The network interface 162 (FIG. 1) may also be configured to transmit data units the same as or similar to the data unit 200 to the AP 114. The PPDU 200 may occupy a 20 MHz bandwidth or another suitable bandwidth. PHY protocol data units similar to the PPDU 200 occupy other suitable bandwidth such as 40 MHz, 80 MHz, 160 MHz, 320 MHz, 640 MHz, for example, or other suitable bandwidths, in other embodiments.

The PPDU 200 includes a preamble 202 including a legacy short training field (L-STF) 205, a legacy long training field (L-LTF) 210, a legacy signal field (L-SIG) 215, a repeated L-SIG field (RL-SIG) 218, a high efficiency (HE) signal field (HE-SIG-A) 220, an HE short training field (HE-STF) 225, and M HE long training fields (HE-LTFs) 230, where M is a suitable positive integer. In an embodiment, M generally corresponds to (e.g., is greater than or equal to) a number of spatial streams via which the data unit 200 will be transmitted. A legacy preamble portion 242 of the preamble 202 includes the L-STF 205, L-LTF 210 and L-SIG 215. An HE preamble portion 244 of the preamble 202 includes the RL-SIG 218, the HE-SIG-A 220, the HE-STF 225 and the M HE-LTFs 230. The data unit 200 also includes a data portion 240. In some scenarios, the PPDU 200 may omit the data portion 240.

The L-STF 205 generally includes information that is useful for packet detection and synchronization, whereas the L-LTF 210 generally includes information that is useful for channel estimation and fine synchronization. The L-SIG 215 generally signals PHY parameters to the receiving devices, including legacy devices, such as a length of the PPDU 200.

The HE-STF 225 generally includes information that is useful for improving automatic gain control estimation in a MIMO transmission. The HE-LTFs 230 generally includes information that is useful for estimating a MIMO channel.

In some embodiments, the preamble 202 omits one or more of the fields 205-230. In some embodiments, the preamble 202 includes additional fields not illustrated in FIG. 2A.

Each of the L-STF 205, the L-LTF 210, the L-SIG 215, the RL-SIG 218, the HE-SIG-A 220, the HE-STF 225, and the M HE-LTFs 230 comprises one or more OFDM symbols. As merely an illustrative example, the HE-SIG-A 220 comprises two OFDM symbols.

In the illustration of FIG. 2A, the PPDU 200 includes one of each of the L-STF 205, the L-LTF 210, the L-SIG 215, the RL-SIG 218 and the HE-SIG-A 220. In some embodiments in which a data unit similar to the data unit 200 occupies a cumulative bandwidth other than 20 MHz, each of the L-STF 205, the L-LTF 210, the L-SIG 215, the RL-SIG 218, and the HE-SIG-A 220 is repeated over a corresponding number of 20 MHz sub-bands of the whole bandwidth of the data unit, in an embodiment. For example, in an embodiment in which the data unit occupies an 80 MHz bandwidth, the PPDU 200 includes four of each of the L-STF 205, the L-LTF 210, the L-SIG 215, the RL-SIG 218, and the HE-SIG-A 220 in respective 20 MHz sub-bands.

In an embodiment, the HE-SIG-A 220 generally carries information about the format of the PPDU 200, such as information needed to properly decode at least a portion of the PPDU 200, in an embodiment. In some embodiments, HE-SIG-A 220 additionally includes information for receivers that are not intended receivers of the PPDU 200, such as information needed for medium protection, spatial reuse, etc.

In some embodiments, a format similar to the format in FIG. 2A is defined for an extended range SU PPDU, where a duration of an HE-SIG-A field is twice the duration of the HE-SIG-A 220. For example, in an embodiment, information in the HE-SIG-A field 220 is included twice so that the duration of the HE-SIG-A field in the extended range SU PPDU is twice the duration of the HE-SIG-A 220.

FIG. 2B is a diagram of a multi-user PPDU 250 that the network interface 122 (FIG. 1) is configured to transmit to multiple client stations 154, according to an embodiment. The network interface 162 (FIG. 1) may also be configured to generate and transmit data units the same as or similar to the PPDU 250. The PPDU 250 may occupy a 20 MHz bandwidth or another suitable bandwidth. PPDUs similar to the PPDU 250 occupy other suitable bandwidth such as 40 MHz, 80 MHz, 160 MHz, 320 MHz, 640 MHz, for example, or other suitable bandwidths, in other embodiments.

In an embodiment, the PPDU 250 is a downlink (DL) orthogonal frequency division multiple access (OFDMA) unit in which independent data streams are transmitted to multiple client stations 154 using respective sets of OFDM tones and, in some cases respective spatial streams, allocated to the client stations 154. For example, in an embodiment, available OFDM tones (e.g., OFDM tones that are not used as DC tone and/or guard tones) are segmented into multiple resource units (RUs), and each of the multiple RUs is allocated to transmissions to one or more client stations 154. The PPDU 250 is similar to the PPDU 200 of FIG. 2A, and like-numbered elements are not described again in detail for purposes of brevity.

The PPDU 250 includes a preamble 252 similar to the preamble 202 (FIG. 2A). The preamble 262 includes an HE portion 254 similar to the HE portion 244 (FIG. 2A). The HE portion 254 includes an HE signal field (HE-SIG-B) 260.

In an embodiment in which a PPDU similar to the PPDU 250 occupies a cumulative bandwidth greater than 20 MHz, multiple HE-SIG-B portions that include information for different sets of client stations are transmitted over different frequency sub-bands. For example, a first HE-SIG-B portion is transmitted in an odd-numbered 20 MHz sub-band and includes information for client stations assigned to transmit over odd-numbered 20 MHz sub-band(s), and a second HE-SIG-B portion is transmitted in an even-numbered 20 MHz sub-band and includes information for client stations assigned to transmit over even numbered 20 MHz sub-band(s), according to an embodiment. The first HE-SIG-B portion is sometimes referred to as “HE-SIG-B content channel 1”, and the second HE-SIG-B portion is sometimes referred to as “HE-SIG-B content channel 2”. For cumulative bandwidths larger than 40 MHz, the HE-SIG-B content channel 1 (which includes information for client stations assigned to transmit over odd-numbered 20 MHz sub-bands) is repeated over corresponding odd numbered 20 MHz sub-bands, and the HE-SIG-B content channel 2 (which includes information for client stations assigned to transmit over even-numbered 20 MHz sub-bands) is repeated over corresponding even numbered 20 MHz sub-bands. The 20 MHz sub-bands are numbered starting from one and ordered in increasing order of absolute frequency, according to an embodiment.

The HE-SIG-A 220 and the HE-SIG-B 260 generally carry information about the format of the PPDU 250, such as information needed to properly decode at least a portion of the PPDU 250, in an embodiment. The HE-SIG-A 220 carries information commonly needed by multiple intended receivers of the PPDU 250. On the other hand, the HE-SIG-B 260 carries user-specific information individually needed by each intended receiver of the PPDU 250. In an embodiment, HE-SIG-A 220 includes information needed to properly decode HE-SIG-B 260, and HE-SIG-B 260 includes information needed to properly decode data streams in the data portion 240 of the PPDU 250.

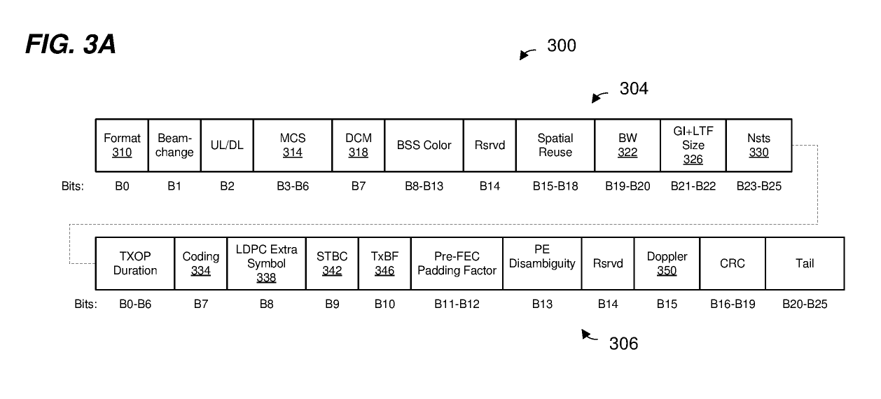

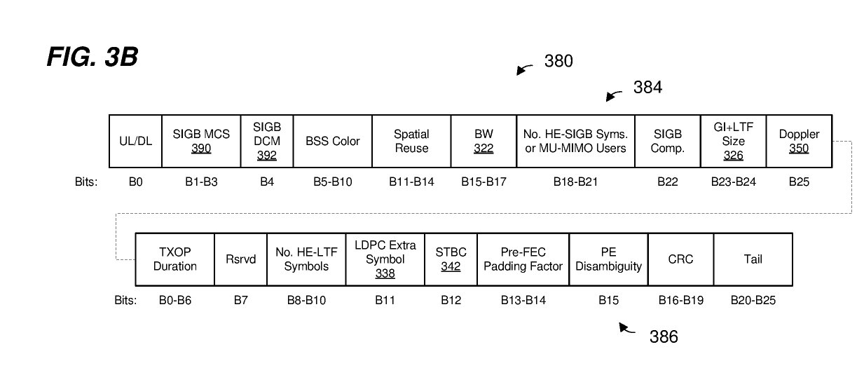

FIG. 3A is a diagram of an example HE-SIG-A field 300 for a SU PPDU, such as the HE-SIG-A 220 of FIG. 2A, according to an embodiment. In some embodiments, the HE-SIG-A field 300 is also for an extended range PPDU. Not all of the subfields illustrated in FIG. 3A discussed in detail for purposes of brevity. FIG. 3A illustrates example numbers of bits and bit positions within the HE-SIG-A field 300. For example, the letter “B” indicates a bit, and the numbers following “B” indicates a relative position within the HE-SIG-A field 300, where “BO” indicates a least significant bit that is transmitted first. In other embodiments, other suitable numbers of bits and bit positions are utilized. Similarly, in other embodiments, one or more of the illustrated subfields are omitted and/or one or more additional subfields are included in the HE-SIG-A field 300.

The HE-SIG-A field 300 includes a first part 304 (bits B0 to B25) that is transmitted first and a second part 306 (bits B0 to B25) that is transmitted after the first part 304. In an embodiment, the first part 304 is included in a first OFDM symbol, and the second part 306 is included in a second OFDM symbol, where the first OFDM symbol is transmitted prior to the second OFDM symbol.

A format subfield 310 indicates whether the PPDU that includes the HE-SIG-A field 300 is an SU PPDU or a trigger-based PPDU. Thus, when the PPDU that includes the HE-SIG-A field 300 is an SU PPDU, the format subfield 310 is set to a value that indicates the PPDU is an SU PPDU. For an extended range PPDU, the subfield 310 is reserved and set to a predefined value, according to an embodiment.

A modulation and coding scheme (MCS) subfield 314 indicates an MCS utilized for a data portion of the PPDU, where the utilized MCS is selected from a set of MCSs defined by a communication protocol. A dual carrier modulation (DCM) subfield 318 indicates whether DCM is used for the data portion of the PPDU. DCM involves transmitting the same data at different frequencies, and thus provides frequency diversity. In some embodiments, the communication protocol specifies that DCM is permitted for only a subset of MCSs defined by the communication protocol.

A bandwidth (BW) subfield 322 indicates a frequency bandwidth of the PPDU. For example, the communication protocol permits transmissions at different frequency bandwidths, and the BW subfield 322 indicates a frequency bandwidth of the transmission, according to an embodiment.

A guard interval duration and HE-LTF size (GI+LTF size) subfield 326 indicates i) a guard interval (GI) duration used in the HE-LTFs 230 and the data portion of the PPDU, and ii) a size of each of the HE-LTFs 230. For example, the communication protocol defines multiple GI durations that can be used, as well as multiple sizes of the HE-LTFs 230 that can be used, according to an embodiment. GIs are included between adjacent OFDM symbols to reduce inter-symbol interference (ISI) caused by multipath reflections, for example. ISI generally increases with longer range transmissions. Generally, a longer GI duration decreases ISI but reduces the data rate. In better channel conditions and/or for shorter range communications, a shorter GI duration can be used, at least in some embodiments. HE-LTFs are used by a receiver to calculate a channel estimate for purposes of equalization, beamforming, etc., for example. Generally, a longer LTF facilitates generating a more accurate channel estimate (especially for longer range communications with longer delay spread), but increases overhead (e.g., more medium time is devoted to transmission of training signals rather than data). In better channel conditions and/or for shorter range communications, a shorter HE-LTF size can be used, at least in some embodiments.

A number of space-time streams (Nsts) subfield 330 indicates a number of space-time streams used in the data portion of the PPDU. A coding subfield 334 indicates a type of error correction code (ECC) uses in the data portion of the PPDU. For example, in an embodiment, the communication protocol defines multiple ECC options such as binary convolutional coding (BCC), low density parity check (LDPC), etc.

An LDPC extra symbol subfield 338 indicates whether, when LDPC encoding is used, an extra OFDM symbol is added to data portion of the PPDU. For example, in connection with LDPC coding of the data portion of the PPDU, an extra OFDM symbol is added to the PPDU, and the LDPC extra symbol subfield 338 is set to indicate the extra OFDM symbol, according to an embodiment. If LDPC encoding is not used, the LDPC extra symbol subfield 338 is set to a predetermined value, according to an embodiment. Thus, for example, if the coding subfield 334 is set to a value that indicates that LDPC encoding is not used, the LDPC extra symbol subfield 338 is set to the predetermined value, according to an embodiment.

A space-time block coding (STBC) subfield 342 indicates whether STBC is used for the data portion of the PPDU. In an embodiment, the communication protocol does not permit both DCM and STBC for a PPDU. A transmit beamforming (TxBF) subfield indicates whether the data portion of the PPDU is transmitted using TxBF. A Doppler field 350 indicates whether the data portion of the PPDU is transmitted using a Doppler mode, e.g., a PHY protocol mode that provides enhanced performance when a communication device is moving during a transmission.

FIG. 3B is a diagram of an example HE-SIG-A field 380 for a multi-user (MU) PPDU, according to an embodiment. Not all of the subfields illustrated in FIG. 3B discussed in detail for purposes of brevity. FIG. 3B illustrates example numbers of bits and bit positions within the HE-SIG-A field 380. In other embodiments, other suitable numbers of bits and bit positions are utilized. Similarly, in other embodiments, one or more of the illustrated subfields are omitted and/or one or more additional subfields are included in the HE-SIG-A field 380.

The HE-SIG-A field 380 includes some of the same subfields discussed with respect to the example HE-SIG-A field 300 of FIG. 3A, and like-numbered fields are not discussed in detail for purposes of brevity.

The HE-SIG-A field 380 includes a first part 384 (bits B0 to B25) that is transmitted first and a second part 386 (bits B0 to B25) that is transmitted after the first part 364. In an embodiment, the first part 384 is included in a first OFDM symbol, and the second part 386 is included in a second OFDM symbol, where the first OFDM symbol is transmitted prior to the second OFDM symbol.

The HE-SIG-A field 380 also includes the BW subfield 322, the GI+LTF Size subfield 326, the LDPC extra symbol subfield 338, the STBC subfield 342, and the Doppler subfield 350 discussed above. The HE-SIG-A field 380 also includes a SIGB MCS subfield 390 that indicates an MCS used for the HE-SIGB field 260 (FIG. 2B). The HE-SIG-A field 380 also includes a SIGB DCM subfield 392 that indicates whether the HE-SIGB field 260 (FIG. 2B) is transmitted using DCM.

Referring now to FIGS. 3A and 3B, the GI+LTF Size subfield 326 consists of two bits, and a maximum of four different combinations of GI duration and HE-LTF size can be specified by two bits. In an embodiment, however, the communication protocol specifies at least five different combinations of GI duration and HE-LTF size. For example, in an embodiment, the communication protocol specifies at least the combinations of GI duration and HE-LTF size in Table 1.

TABLE 1

| HE-LTF Size | GI Duration |
|---|---|
| 1x HE-LTF | 0.8 microseconds |
| 2x HE-LTF | 0.8 microseconds |
| 2x HE-LTF | 1.6 microseconds |
| 4x HE-LTF | 3.2 microseconds |
| 4x HE-LTF | 0.8 microseconds |

1×HE-LTF, 2×HE-LTF, and 4×HE-LTF are different lengths of the HE-LTF field defined by the communication protocol. For example, 2×HE-LTF is twice the length of 1×HE-LTF, and 4×HE-LTF is four times the length of 1×HE-LTF, according to an embodiment.

In some embodiments, one of the four possible values of the GI+LTF Size subfield 326 is used to indicate one of two different combinations of GI duration and HE-LTF size by selectively setting one or more other fields in a signal field in a PHY protocol preamble, such as the HE-SIG-A field 300 and/or the HE-SIG-A field 380, to a value or combination of values that indicates a PHY protocol mode not permitted by the communication protocol (i.e., an invalid PHY mode). For example, a particular value of the GI+LTF Size subfield 326 indicates i) a first GI duration and HE-LTF size combination when a set of one or more other fields in the signal field of the PHY protocol preamble indicates a valid PHY mode permitted by the communication protocol, and ii) a second GI duration and HE-LTF size combination when the set of one or more other fields in the signal field of the PHY protocol preamble indicates an invalid valid PHY mode, according to an embodiment.

Table 2 is a listing of example values of the GI+LTF Size subfield 326, and corresponding combinations of GI duration and LTF sizes, according to an embodiment. The example values of Table 2 are used for SU PPDUs, in some embodiments. In the embodiment corresponding to Table 2, the communication protocol does not permit DCM mode and STBC to be used at the same time.

TABLE 2

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If both DCM subfield 318 and STBC |
| | subfield 342 are set to 1, then: 4x HE- |
| | LTF, 0.8 microseconds GI; |
| | Otherwise: 4x HE-LTF, 3.2 microseconds |
| | GI |

In an embodiment, setting the DCM subfield 318 to one indicates DCM mode is used, and setting the STBC subfield 342 to one indicates STBC is used; but the communication protocol does not permit DCM mode and STBC to be used at the same time. Thus, setting both the DCM subfield 318 and the STBC subfield 342 to one indicates an invalid PHY mode.

Table 3 is a listing of example values of the GI+LTF Size subfield 326, and corresponding combinations of GI duration and LTF sizes, according to an embodiment. The example values of Table 3 are used for SU PPDUs, in some embodiments. In the embodiment corresponding to Table 3, the communication protocol permits DCM mode to be used only for a subset of possible MCSs, e.g., DCM can only be used for MCSs corresponding to MCS subfield 314 values zero, one, three, or four.

TABLE 3

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If MCS subfield 314 is set to 2 or greater |
| | than 4, and DCM subfield 318 is set to 1, |
| | then: 4x HE-LTF, 0.8 microseconds GI; |
| | Otherwise: 4x HE-LTF, 3.2 microseconds |
| | GI |

In an embodiment, setting the DCM subfield 318 to one and setting the MCS subfield 314 to two or greater than four corresponds to an invalid PHY mode because the communication protocol permits DCM to be used only for MCSs corresponding to MCS subfield 314 values zero, one, three, or four.

Table 4 is a listing of example values of the GI+LTF Size subfield 326, and corresponding combinations of GI duration and LTF sizes, according to an embodiment. The example values of Table 4 are used for SU PPDUs, in some embodiments. In the embodiment corresponding to Table 4, the communication protocol permits DCM mode to be used only when one or two space-time streams are used.

TABLE 4

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If Nsts subfield 342 is set to 2 or more, |
| | and DCM subfield 318 is set to 1, then: 4x |
| | HE-LTF, 0.8 microseconds GI; |
| | Otherwise: 4x HE-LTF, 3.2 microseconds |
| | GI |

In an embodiment, the Nsts subfield 342 is set to the number of space-time streams minus one. Setting the DCM subfield 318 to one and setting the Nsts subfield 342 to two or more corresponds to an invalid PHY mode because the communication protocol permits DCM to be used only for numbers of space-time streams corresponding to Nsts subfield 342 values of zero or one.

Table 5 is a listing of example values of the GI+LTF Size subfield 326, and corresponding combinations of GI duration and LTF sizes, according to an embodiment. The example values of Table 5 are used for SU PPDUs, in some embodiments. In the embodiment corresponding to Table 5, the communication protocol specifies that the LDPC extra symbol subfield 338 is to be set to one if LDPC is not being used.

TABLE 5

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If both the coding subfield 334 and the |
| | LDPC extra symbol subfield 338 are set to |
| | 0, then: 4x HE-LTF, 0.8 microseconds GI; |
| | Otherwise: 4x HE-LTF, 3.2 microseconds |
| | GI |

In an embodiment, setting the coding subfield 334 to zero indicates a coding technique (e.g., BCC) that is not LDPC is used, and the communication protocol specifies that the LDPC extra symbol subfield 338 is to be set to one when LDPC is not used. Thus, setting both the coding subfield 334 and the LDPC extra symbol subfield 338 to zero indicates an invalid PHY mode.

Tables 2-5 were discussed in the context of SU PPDUs. The same or similar techniques are used for extended range PPDUs, in some embodiments. For example, the field values, GI durations, and HE-LTF sizes in Tables 2, 4, and 5 are used with extended range PPDUs, in various embodiments.

Table 6 is a listing of example values of the GI+LTF Size subfield 326, and corresponding combinations of GI duration and LTF sizes, according to an embodiment. The example values of Table 6 are used for extended range PPDUs, in some embodiments. In the embodiment corresponding to Table 6, the communication protocol defines for extended range PPDUs only a first bandwidth setting (BW subfield 322=0) corresponding to a 242-tone resource unit (RU) in a primary 20 MHz channel, and a second bandwidth setting (BW subfield 322=1) corresponding to a 106-tone RU in an upper half of the primary 20 MHz channel; values 2 and 3 of the BW subfield 322 are reserved. Additionally, when the BW subfield 322 is set to indicate the second bandwidth setting (e.g., BW subfield 322=1), the communication protocol permits only one MCS, e.g., MCS subfield 314=0.

TABLE 6

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If MCS subfield 314 is set to greater than |
| | 0, and BW subfield 322 is set to 1, then: |
| | 4x HE-LTF, 0.8 microseconds GI; |
| | Otherwise: 4x HE-LTF, 3.2 microseconds |
| | GI |

In an embodiment, setting the BW subfield 322 to one and setting the MCS subfield 314 to greater than zero (for an extended range PPDU) corresponds to an invalid PHY mode because the communication protocol only permits an MCS corresponding to an MCS subfield 314 value of zero when the BW subfield 322 is set to one (e.g., corresponding to a 106-tone RU in an upper half of a primary 20 MHz channel) for an extended range PPDU.

Table 7 is a listing of example values of the GI+LTF Size subfield 326, and corresponding combinations of GI duration and LTF sizes, according to an embodiment. The example values of Table 7 are used for extended range PPDUs, in some embodiments. In the embodiment corresponding to Table 7, the communication protocol defines for extended range PPDUs only a first bandwidth setting (BW subfield 322=0) corresponding to a 242-tone RU in the primary 20 MHz channel, and a second bandwidth setting (BW subfield 322=1) corresponding to a 106-tone RU in an upper half of the primary 20 MHz channel; values 2 and 3 of the BW subfield 322 are reserved. Additionally, the communication protocol permits a subset of possible MCSs when the BW subfield 322 is set to zero for extended range PPDUs, e.g., only MCSs corresponding to MCS subfield 314 values zero, one, or two are permitted. Further, the communication protocol permits DCM mode to be used only for a subset of possible MCSs, e.g., DCM can only be used for MCSs corresponding to MCS subfield 314 values zero, one, three, or four.

TABLE 7

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If BW subfield 322 is set to 0, MCS |
| | subfield 314 is set to 2, and DCM subfield |
| | 318 is set to 1, then: 4x HE-LTF, 0.8 |
| | microseconds GI; |
| | Otherwise: 4x HE-LTF, 3.2 microseconds |
| | GI |

In an embodiment, setting the BW subfield 322 to zero, the DCM subfield 318 to one, and the MCS subfield 314 to two corresponds to an invalid PHY mode because the communication protocol permits DCM to be used only for MCSs corresponding to MCS subfield 314 values zero, one, three, or four.

Table 8 is a listing of example values of the GI+LTF Size subfield 326, and corresponding combinations of GI duration and LTF sizes, according to an embodiment. The example values of Table 8 are used for extended range PPDUs, in some embodiments. In the embodiment corresponding to Table 8, the communication protocol defines for extended range PPDUs only a first bandwidth setting (BW subfield 322=0) corresponding to a 242-tone RU in the primary 20 MHz channel, and a second bandwidth setting (BW subfield 322=1) corresponding to a 106-tone RU in an upper half of the primary 20 MHz channel; values 2 and 3 of the BW subfield 322 are reserved.

TABLE 8

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If BW subfield 322 is set to 2 or 3, then: |
| | 4x HE-LTF, 0.8 microseconds GI; |
| | Otherwise: 4x HE-LTF, 3.2 microseconds |
| | GI |

In an embodiment, setting the BW subfield 322 to two or three for an extended range PPDU corresponds to an invalid PHY mode because the communication protocol only defines valid BW subfield 322 settings of zero or one (e.g., BW subfield 322 settings of two or three correspond to reserved values) for an extended range PPDU.

In some embodiments, one of the four possible values of the GI+LTF Size subfield 326 is used to indicate one of two different combinations of GI duration and HE-LTF size by selectively setting one or more other fields in a signal field in a PHY protocol preamble, such as the HE-SIG-A field 300 and/or the HE-SIG-A field 380, to a value or combination of values that indicates a PHY protocol mode for which a shorter GI is acceptable. For example, a particular value of the GI+LTF Size subfield 326 indicates i) a first GI duration and HE-LTF size combination when a set of one or more other fields in the signal field of the PHY protocol preamble indicates a PHY mode for which a longer GI duration is required, and ii) a second GI duration and HE-LTF size combination when the set of one or more other fields in the signal field of the PHY protocol preamble indicates a PHY mode for which a shorter GI is duration acceptable, according to an embodiment.

Table 9 is a listing of example values of the GI+LTF Size subfield 326, and corresponding combinations of GI duration and LTF sizes, according to an embodiment. The example values of Table 9 are used for SU PPDUs, in some embodiments. In the embodiment corresponding to Table 9, it is assumed that when transmit beamforming is utilized, a shorter GI duration is acceptable.

TABLE 9

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If TxBF subfield 346 is set to indicate that |
| | transmit beamforming is being used, then: |
| | 4x HE-LTF, 0.8 microseconds GI; |
| | Otherwise: 4x HE-LTF, 3.2 microseconds |
| | GI |

Table 10 is a listing of example values of the GI+LTF Size subfield 326, and corresponding combinations of GI duration and LTF sizes, according to an embodiment. The example values of Table 10 are used for SU PPDUs, in some embodiments. In the embodiment corresponding to Table 10, it is assumed that longer range transmissions that require a longer GI duration will utilize transmit beamforming and a Doppler mode; thus, if transmit beamforming is being used, but the Doppler mode is not being used, then the transmission is not a long range transmission that requires the longer GI duration, i.e., a shorter GI duration is acceptable.

TABLE 10

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If TxBF subfield 346 is set to indicate that |
| | transmit beamforming is being used and |
| | the Doppler subfield 350 is set to indicate |
| | that the Doppler mode is not being used, |
| | then: 4x HE-LTF, 0.8 microseconds GI; |
| | Otherwise: 4x HE-LTF, 3.2 microseconds |
| | GI |

In an embodiment, for MU transmissions, the communication protocol defines a specific value of the GI+LTF Size subfield 326 that specifies the combination 4×HE-LTF, 0.8 microseconds GI. For example, the example values of Table 11 are used for MU PPDUs, in some embodiments, where Table 11 is a listing of example values of the GI+LTF Size subfield 326, and corresponding combinations of GI duration and LTF sizes.

TABLE 11

| GI + LTF Size subfield 326 | GI Duration and LTF size |
|---|---|
| 0 | 4x HE-LTF, 0.8 microseconds GI |
| 1 | 2x HE-LTF, 0.8 microseconds GI |
| 2 | 2x HE-LTF, 1.6 microseconds GI |
| 3 | 4x HE-LTF, 3.2 microseconds GI |

In an embodiment, for MU transmissions, the communication protocol defines a specific value of the GI+LTF Size subfield 326 that specifies the combination 4×HE-LTF, 0.8 microseconds GI. For example, the example values of Table 11 are used for MU PPDUs, in some embodiments, where Table 11 is a listing of example values of the GI+LTF Size subfield 326, and corresponding combinations of GI duration and LTF sizes.

In some embodiments, for MU transmissions, a particular value of the GI+LTF Size subfield 326 indicates i) a first GI duration and HE-LTF size combination when a set of one or more other fields in the signal field of the PHY protocol preamble indicates a valid PHY mode permitted by the communication protocol, and ii) a second GI duration and HE-LTF size combination when the set of one or more other fields in the signal field of the PHY protocol preamble indicates an invalid valid PHY mode, according to an embodiment.

Table 12 is a listing of example values of the GI+LTF Size subfield 326 for MU transmissions, and corresponding combinations of GI duration and LTF sizes, according to an embodiment. In the embodiment corresponding to Table 12, the communication protocol permits DCM mode to be used for the HE-SIG-B field only for a subset of possible MCSs for the HE-SIG-B field, e.g., for the HE-SIG-B field, DCM can only be used for MCSs corresponding to SIGB MCS subfield 390 values zero, one, three, or four.

TABLE 12

| GI + LTF Size subfield 326 | GI Duration and LTF size |
|---|---|
| 0 | 1x HE-LTF, 0.8 microseconds GI |
| 1 | 2x HE-LTF, 0.8 microseconds GI |
| 2 | 2x HE-LTF, 1.6 microseconds GI |
| 3 | If SIGB MCS subfield 390 is set to 2 or |
| | greater than 4, and SIGB DCM subfield |
| | 392 is set to 1, then: 4x HE-LTF, 0.8 |
| | microseconds GI; |
| | Otherwise: 4x HE-LTF, 3.2 microseconds |
| | GI |

In an embodiment, setting the SIGB DCM subfield 392 to one and setting the SIGB MCS subfield 390 to two or greater than four corresponds to an invalid PHY mode because the communication protocol permits DCM to be used for the HE-SIG-B field only for MCSs corresponding to SIGB MCS subfield 390 values zero, one, three, or four.

In some embodiments, for MU PPDUs, transmit beamforming is always used. Table 13 is a listing of example values of the GI+LTF Size subfield 326 for MU PPDUs, and corresponding combinations of GI duration and LTF sizes, according to an embodiment. In the embodiment corresponding to Table 13, it is assumed that when transmit beamforming is utilized, a shorter GI duration is acceptable. It is also assumed that the 1×HE-LTF size cannot be used for MU PPDUs.

TABLE 13

| GI + LTF Size subfield 326 | GI Duration and LTF size |
|---|---|
| 0 | reserved |
| 1 | 2x HE-LTF, 0.8 microseconds GI |
| 2 | 2x HE-LTF, 1.6 microseconds GI |
| 3 | 4x HE-LTF, 0.8 microseconds GI |

In some embodiments, for MU PPDUs, one of the four possible values of the GI+LTF Size subfield 326 is used to indicate one of two different combinations of GI duration and HE-LTF size by selectively setting one or more other fields in a signal field in a PHY protocol preamble, such as the HE-SIG-A field 380, to a value or combination of values that indicates a PHY protocol mode for which a shorter GI is acceptable.

Table 14 is a listing of example values of the GI+LTF Size subfield 326 for MU PPDUs, and corresponding combinations of GI duration and LTF sizes, according to an embodiment. In the embodiment corresponding to Table 14, it is assumed that longer range MU transmissions that require a longer GI duration will utilize a Doppler mode; thus, if the Doppler mode is not being used for an MU PPDU, then the transmission is not a long range transmission that requires the longer GI duration, i.e., a shorter GI duration is acceptable.

TABLE 14

| GI + LTF Size subfield 326 | GI Duration and LTF size |
|---|---|
| 0 | reserved |
| 1 | 2x HE-LTF, 0.8 microseconds GI |
| 2 | 2x HE-LTF, 1.6 microseconds GI |
| 3 | If the Doppler subfield 350 is set to |
| | indicate that the Doppler mode is not |
| | being used, then: 4x HE-LTF, 0.8 |
| | microseconds GI; |
| | Otherwise: 4x HE-LTF, 3.2 microseconds |
| | GI |

In embodiments described, a shorter GI duration for use with the longer HE-LTF size (e.g., 4×HE-LTF) is described as being equal to 0.8 microseconds. In other embodiments, however, the shorter GI duration for use with the longer HE-LTF size (e.g., 4×HE-LTF) is another suitable duration, such as 0.4 microseconds.

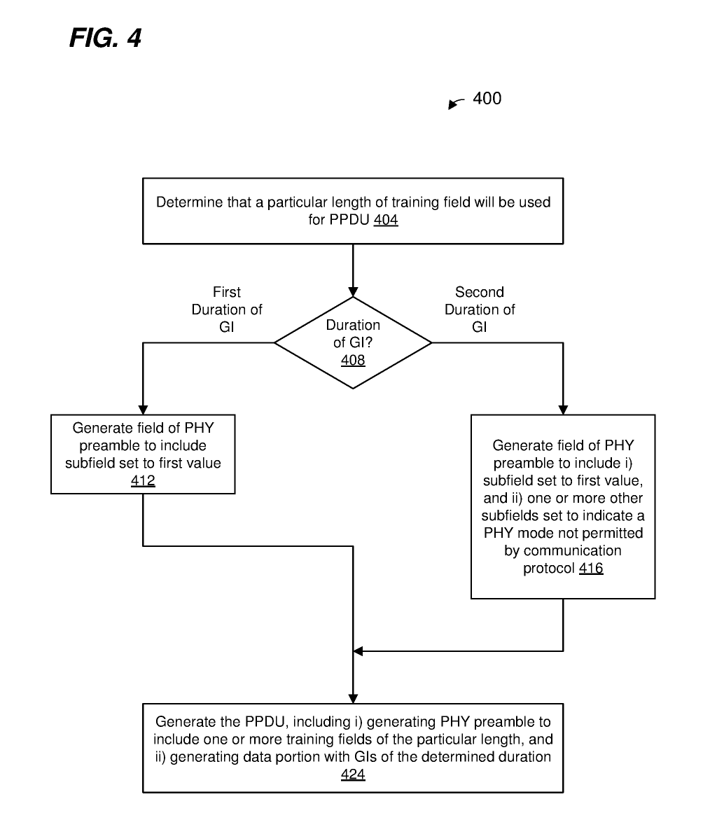

FIG. 4 is a flow diagram of an example method 400 for generating a PPDU, according to an embodiment. In some embodiments, the network interface device 122 (e.g., the PHY processor 130) and/or the network interface device 162 (e.g., the PHY processor 170) of FIG. 1 is configured to implement the method 400. The method 400 is described in the context of the network interface device 122 merely for explanatory purposes and for brevity, and the method 400 is implemented by another suitable device, in other embodiments.

The method 400 is used in the context of a communication protocol that specifies a plurality of allowed lengths of a training field (e.g., the HE-LTF field 230 or another suitable training field) in a PHY preamble (e.g., the PHY preamble 202, the PHY preamble 252, or another suitable PHY preamble) of the PPDU (e.g., the PPDU 200, the PPDU 250, or another suitable PPDU), and plurality of allowed durations of a guard interval (GI) corresponding to a spacing between transmission symbols in the PPDU.

At block 404, the network interface device 122 (e.g., the PHY processor 130) determines that a particular length of the training field will be used for the PPDU, the particular length from among a plurality of multiple different lengths of training fields specified by a communication protocol. For example, in an embodiment, the network interface device 122 (e.g., the PHY processor 130) determines that the 4×HE-LTF will be used for each of the one or more HE-LTFs in the PPDU.

At block 408, the network interface device 122 (e.g., the PHY processor 130) determines whether a first duration of the GI or a second duration of the GI will be used for the PPDU. For example, in an embodiment, the network interface device 122 (e.g., the PHY processor 130) determines whether a 3.2 microsecond duration or a 0.8 microsecond duration of the GI will be used for the PPDU.

If it is determined at block 408 that the first duration of the GI will be used, the flow proceeds to block 412. At block 412, the network interface device 122 (e.g., the PHY processor 130) generates a field (e.g., the HE-SIG-A field 220) of the PHY preamble to include a subfield (e.g., the GI+LTF Size subfield 326) set to a first value, the first value indicating that the PPDU uses the particular length of the training field (block 404) and the first duration of the GI. For example, in embodiments corresponding to Tables 2-8 and 12, the first value is three. In other embodiments, the first value is a suitable value other than three.

On the other hand, if it is determined at block 408 that the second duration of the GI will be used, the flow proceeds to block 416. At block 416, the network interface device 122 (e.g., the PHY processor 130) generates the field (e.g., the HE-SIG-A field 220) of the PHY preamble to include i) the subfield (e.g., the GI+LTF Size subfield 326) set to the first value, and ii) one or more other subfields set to one or more second values that correspond to a PHY mode that is not permitted by the communication protocol. For example, the STBC subfield 342 and the DCM subfield 318 are set as described in connection with Table 2 (e.g., setting the one or more other subfields to the one or more second values corresponds to setting the STBC subfield 342 and the DCM subfield 318 to one), according to an embodiment. In other embodiments, the one or more second values are one or more other suitable values. As another example, the MCS subfield 314 and the DCM subfield 318 are set as described in connection with Table 3 (e.g., setting the one or more other subfields to the one or more second values corresponds to setting the MCS subfield 314 to two or greater than four, and setting the DCM subfield 318 to one), according to an embodiment. In other embodiments, the one or more second values are one or more other suitable values. As another example, the Nsts subfield 330 and the DCM subfield 318 are set as described in connection with Table 4 (e.g., setting the one or more other subfields to the one or more second values corresponds to setting the Nsts subfield 330 to two or more, and setting the DCM subfield 318 to one), according to an embodiment. In other embodiments, the one or more second values are one or more other suitable values. As another example, the coding subfield 334 and the LDPC Extra Symbol subfield 338 are set as described in connection with Table 5 (e.g., setting the one or more other subfields to the one or more second values corresponds to setting the coding subfield 334 and the LDPC Extra Symbol subfield 338 to zero), according to an embodiment. In other embodiments, the one or more second values are one or more other suitable values. As another example, the MCS subfield 314 and the BW subfield 322 are set as described in connection with Table 6 (e.g., setting the one or more other subfields to the one or more second values corresponds to setting the MCS subfield 314 to greater than zero, and setting the BW subfield 322 to one), according to an embodiment. In other embodiments, the one or more second values are one or more other suitable values. As another example, the MCS subfield 314, the DCM field 318, and the BW subfield 322 are set as described in connection with Table 7 (e.g., setting the one or more other subfields to the one or more second values corresponds to setting the MCS subfield 314 to two, setting the DCM field 318 to one, and setting the BW subfield 322 to zero), according to an embodiment. In other embodiments, the one or more second values are one or more other suitable values. As another example, the BW subfield 322 is set as described in connection with Table 8 (e.g., setting the one or more other subfields to the one or more second values corresponds to setting the BW subfield 322 to two or three), according to an embodiment. In other embodiments, the one or more second values are one or more other suitable values. As another example, the SIGB MCS subfield 390 and the SIGB DCM subfield 392 are set as described in connection with Table 12 (e.g., setting the one or more other subfields to the one or more second values corresponds to setting the SIGB MCS subfield 390 to two or greater than four, and setting the SIGB DCM subfield 392 to one), according to an embodiment. In other embodiments, the one or more second values are one or more other suitable values.

At block 424, the network interface device 122 (e.g., the PHY processor 130) generates the PPDU. Block 424 includes generating the PHY preamble to include one or more training fields, each training field having the particular length (block 404). Block 424 also includes generating a data portion of the PHY data unit to use the determined duration (the first duration or the second duration) of the GI, e.g., GIs of the determined duration are included between transmission symbols (e.g., OFDM symbols). In an embodiment, GIs of the determined duration are included between transmission symbols (e.g., OFDM symbols) of both the data portion and at least some training fields in the PHY preamble (e.g., the HE-LTFs).

In an embodiment, the first duration of the GI is 3.2 microseconds, and the second duration of the GI is 0.8 microseconds. In another embodiment, the first duration of the GI is 3.2 microseconds, and the second duration of the GI is 0.4 microseconds. In other embodiments, the first duration of the GI is a suitable time duration different than 3.2 microseconds, and the second duration of the GI is a suitable time duration less than the first duration (e.g., ½ of the first duration, ¼ of the first duration, ⅛ of the first duration, etc.).

In an embodiment, the particular length (block 404) of the training field specified by the communication protocol is a first length (e.g., 4×HE-LTF), and the communication protocol specifies a second length of the training field (e.g., 1×HE-LTF), the second length being one fourth of the first length. In another embodiment, the communication protocol specifies a third length of the training field (e.g., 2×HE-LTF), the third length being one half of the first length.

In an embodiment, the communication protocol defines a plurality of PPDU formats including an SU PPDU and an MU PPDU, and the PPDU is an SU PPDU. In another embodiment, the communication protocol defines a plurality of PPDU formats including an SU PPDU and an MU PPDU, and the PPDU is an MU PPDU. In an embodiment, the communication protocol defines a plurality of PPDU formats including an SU PPDU, an extended range PPDU, and an MU PPDU, and the PPDU is an extended range PPDU.

In some embodiments, the communication protocol requires that the combination of i) the first length of the training field, and ii) the second duration of the GI, can only be used with PPDUs that are transmitted using beamforming. In other embodiments, the communication protocol permits the combination of i) the first length of the training field, and ii) the second duration of the GI, for PPDUs that are not transmitted using beamforming.

In some embodiments, block 416 is modified such that, instead of setting one or more other subfields to indicate a PHY mode not permitted by the communication protocol, the one or more other subfields are set to indicate a valid PHY mode in which a shorter GI is acceptable. For example, the TxBF subfield 346 is set as described in connection with Table 9, according to an embodiment. As another example, the TxBF subfield 346 and the Doppler subfield 350 are set as described in connection with Table 10, according to an embodiment. As another example, the Doppler subfield 350 is set as described in connection with Table 13, according to an embodiment.

In some embodiments, the method further includes transmitting the PPDU via a communication channel. For example, the one or more transceivers 134 generate one or more RF signals, which are transmitted via the one or more antennas 138.

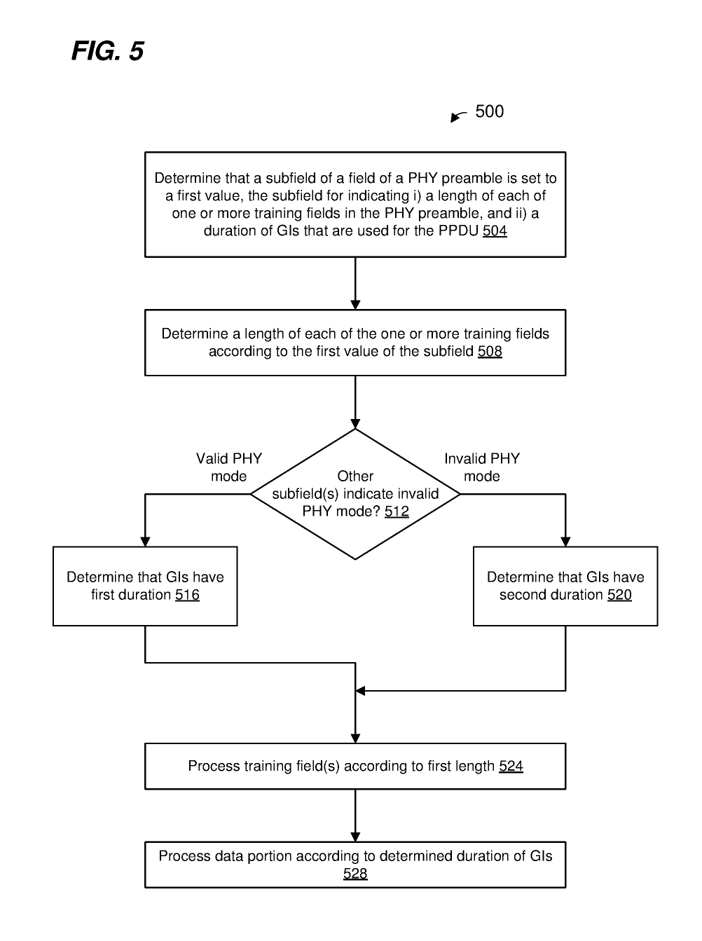

FIG. 5 is a flow diagram of an example method 500 for processing a PPDU received via a communication channel, according to an embodiment. In some embodiments, the network interface device 122 (e.g., the PHY processor 130) and/or the network interface device 162 (e.g., the PHY processor 170) of FIG. 1 is configured to implement the method 400. The method 500 is described in the context of the network interface device 122 merely for explanatory purposes and for brevity, and the method 500 is implemented by another suitable device, in other embodiments.

The method 500 is used in the context of a communication protocol that specifies a plurality of allowed lengths of a training field (e.g., the HE-LTF field 230 or another suitable training field) in a PHY preamble (e.g., the PHY preamble 202, the PHY preamble 252, or another suitable PHY preamble) of the PPDU (e.g., the PPDU 200, the PPDU 250, or another suitable PPDU), and plurality of allowed durations of a guard interval (GI) corresponding to a spacing between transmission symbols in the PPDU.

At block 504, the network interface device 122 (e.g., the PHY processor 130) determines that a subfield in a field of a PHY preamble of the PPDU is set to a first value, wherein the subfield is for indicating i) a length of each of one or more training fields in the PHY preamble, and ii) a duration of GIs that are used for the PPDU. For example, in an embodiment, the field is the HE-SIG-A field 220, and the subfield is the GI+LTF Size subfield 326. As an illustrative example, in embodiments corresponding to Tables 2-8 and 12, the first value is three. In other embodiments, the first value is a suitable value other than three.

At block 508, the network interface device 122 (e.g., the PHY processor 130) determines a length of the training field according to the first value of the subfield. For example, in an embodiment, the network interface device 122 (e.g., the PHY processor 130) determines that the GI+LTF Size subfield 326 is set to the first value (e.g., three), which indicates the 4×HE-LTF length.

At block 512, the network interface device 122 (e.g., the PHY processor 130) determines whether one or more other subfields of the field of the PHY preamble are set to one or more second values that correspond to a PHY mode that is not permitted by the communication protocol (i.e., an invalid PHY mode). For example, the network interface device 122 (e.g., the PHY processor 130) determines whether the STBC subfield 342 and the DCM subfield 318 are set to an invalid PHY mode as described in connection with Table 2 (e.g., the one or more other subfields set to the one or more second values corresponds to the STBC subfield 342 and the DCM subfield 318 set to one), according to an embodiment. As another example, the network interface device 122 (e.g., the PHY processor 130) determines whether the MCS subfield 314 and the DCM subfield 318 are set to an invalid PHY mode as described in connection with Table 3 (e.g., the one or more other subfields set to the one or more second values corresponds to the MCS subfield 314 set to two or greater than four, and the DCM subfield 318 set to one), according to an embodiment. As another example, the network interface device 122 (e.g., the PHY processor 130) determines whether the Nsts subfield 330 and the DCM subfield 318 are set to an invalid PHY mode as described in connection with Table 4 (e.g., the one or more other subfields set to the one or more second values corresponds to the Nsts subfield 330 set to two or more, and the DCM subfield 318 set to one), according to an embodiment. As another example, the network interface device 122 (e.g., the PHY processor 130) determines whether the coding subfield 334 and the LDPC Extra Symbol subfield 338 are set to an invalid PHY mode as described in connection with Table 5 (e.g., the one or more other subfields se to the one or more second values corresponds to the coding subfield 334 and the LDPC Extra Symbol subfield 338 set to zero), according to an embodiment. As another example, the network interface device 122 (e.g., the PHY processor 130) determines whether the MCS subfield 314 and the BW subfield 322 are set to an invalid PHY mode as described in connection with Table 6 (e.g., the one or more other subfields set to the one or more second values corresponds to the MCS subfield 314 set to greater than zero, and the BW subfield 322 set to one), according to an embodiment. As another example, the network interface device 122 (e.g., the PHY processor 130) determines whether the MCS subfield 314, the DCM field 318, and the BW subfield 322 are set to an invalid PHY mode as described in connection with Table 7 (e.g., the one or more other subfields set to the one or more second values corresponds to the MCS subfield 314 set to two, the DCM field 318 set to one, and the BW subfield 322 set to zero), according to an embodiment. As another example, the network interface device 122 (e.g., the PHY processor 130) determines whether the BW subfield 322 is set to an invalid PHY mode as described in connection with Table 8 (e.g., the one or more other subfields set to the one or more second values corresponds to the BW subfield 322 set to two or three), according to an embodiment. As another example, the network interface device 122 (e.g., the PHY processor 130) determines whether the SIGB MCS subfield 390 and the SIGB DCM subfield 392 are set to an invalid PHY mode as described in connection with Table 12 (e.g., the one or more other subfields set to the one or more second values corresponds to the SIGB MCS subfield 390 set to two or greater than four, and the SIGB DCM subfield 392 set to one), according to an embodiment.

If the network interface device 122 (e.g., the PHY processor 130) determines at block 512 that the one or more other subfields of the field of the PHY preamble are not set to one or more second values that correspond to a PHY mode that is not permitted by the communication protocol (i.e., an invalid PHY mode), the flow proceeds to block 516. At block 516, the network interface device 122 (e.g., the PHY processor 130) determines that the PPDU uses GIs having the first duration.

On the other hand, if the network interface device 122 (e.g., the PHY processor 130) determines at block 512 that the one or more other subfields of the field of the PHY preamble are set to one or more second values that correspond to a PHY mode that is not permitted by the communication protocol (i.e., an invalid PHY mode), the flow proceeds to block 520. At block 520, the network interface device 122 (e.g., the PHY processor 130) determines that the PPDU uses GIs having the second duration.

At block 524, the network interface device 122 (e.g., the PHY processor 130) processes the one or more training fields of the PHY preamble according to the length determined at block 508. At block 528, the network interface device 122 (e.g., the PHY processor 130) processes a data portion of the PPDU according to the determined GI duration, e.g., which the network interface device 122 (e.g., the PHY processor 130) determined at either block 516 or block 520.

In an embodiment, the first duration of the GI is 3.2 microseconds, and the second duration of the GI is 0.8 microseconds. In another embodiment, the first duration of the GI is 3.2 microseconds, and the second duration of the GI is 0.4 microseconds. In other embodiments, the first duration of the GI is a suitable time duration different than 3.2 microseconds, and the second duration of the GI is a suitable time duration less than the first duration (e.g., ½ of the first duration, ¼ of the first duration, ⅛ of the first duration, etc.).

In an embodiment, the length of the training field specified by the communication protocol is a first length, and the communication protocol specifies a second length of the training field, the second length being one fourth of the first length. In another embodiment, the communication protocol specifies a third length of the training field, the third length being one half of the first length.

In an embodiment, the communication protocol defines a plurality of PPDU formats including an SU PPDU and an MU PPDU, and the PPDU is an SU PPDU. In another embodiment, the communication protocol defines a plurality of PPDU formats including an SU PPDU and an MU PPDU, and the PPDU is an MU PPDU. In an embodiment, the communication protocol defines a plurality of PPDU formats including an SU PPDU, an extended range PPDU, and an MU PPDU, and the PPDU is an extended range PPDU.

In some embodiments, the communication protocol requires that the combination of i) the first length of the training field, and ii) the second duration of the GI, can only be used with PPDUs that are transmitted using beamforming. In other embodiments, the communication protocol permits the combination of i) the first length of the training field, and ii) the second duration of the GI, for PPDUs that are not transmitted using beamforming.

In some embodiments, block 512 is modified such that, instead of determining whether one or more other subfields are set to indicate a PHY mode not permitted by the communication protocol, the network interface device 122 (e.g., the PHY processor 130) determines whether the one or more other subfields are set to indicate a valid PHY mode in which a shorter GI is acceptable. For example, the network interface device 122 (e.g., the PHY processor 130) determines whether the TxBF subfield 346 is set as described in connection with Table 9, according to an embodiment. As another example, the network interface device 122 (e.g., the PHY processor 130) determines whether the TxBF subfield 346 and the Doppler subfield 350 are set as described in connection with Table 10, according to an embodiment. As another example, the network interface device 122 (e.g., the PHY processor 130) determines whether the Doppler subfield 350 is set as described in connection with Table 13, according to an embodiment.

In an embodiment, a method is for generating a physical layer (PHY) protocol data unit (PPDU) according to a communication protocol that specifies a plurality of allowed lengths of a training field in a PHY preamble of the PPDU, and a plurality of allowed durations of a guard interval (GI) corresponding to a spacing between transmission symbols in the PPDU. The method includes: when a communication device determines that the PPDU is to use a first length of the training field and a first duration of the GI, generating, at the communication device, a field of the PHY preamble to include a subfield set to a first value, the first value indicating that the PPDU uses the first length of the training field and the first duration of the GI; and when the communication device determines that the PPDU is to use the first length of the training field and a second duration of the GI, generating, at the communication device, the field of the PHY preamble to include the subfield set to the first value, and generating, at the communication device, the field of the PHY preamble to include one or more other subfields set to one or more second values that correspond to a PHY mode that is not permitted by the communication protocol, wherein the subfield set to the first value and the one or more other subfields set to the one or more second values indicate that the PPDU uses the first length of the training field and the second duration of the GI. The method also includes generating, at the communication device, the PPDU, including: generating the PHY preamble to include one or more training fields, each training field having the first length, and generating a data portion of the PHY data unit wherein if the communication device determined that the PPDU is to use the first duration of the GI, including GIs of the first duration between transmission symbols of i) the one or more training fields each having the first length and ii) the data portion, and if the communication device determined that the PPDU is to use the second duration of the GI, including GIs of the second duration between transmission symbols of i) the one or more training fields each having the first length and ii) the data portion.

In other embodiments, the method includes one of, or any suitable combination of two or more of, the following features.

The subfield is a first subfield; the one or more other subfields includes i) a second subfield that indicates whether dual carrier modulation (DCM) is to be used for the PPDU, and ii) a third subfield that indicates whether space-time block coding (STBC) is to be used for the PPDU; the communication protocol does not permit both i) DCM to be used for the PPDU, and ii) STBC to be used for the PPDU; and generating the field of the PHY preamble to include one or more second subfields set to one or more second values that correspond to the PHY mode that is not permitted by the communication protocol includes: setting the second subfield to indicate that DCM is used for the PPDU, and setting the third subfield to indicate that STBC is used for the PPDU.

The first duration of the GI is 3.2 microseconds; and the second duration of the GI is 0.8 microseconds.

The length of the training field specified by the communication protocol is a first length; and the communication protocol specifies a second length of the training field, the second length being one fourth of the second length.

In another embodiment, an apparatus comprises a network interface device associated with a first communication device, wherein the network interface device includes one or more integrated circuits (ICs). The one or more ICs are configured to: generate a physical layer (PHY) protocol data unit (PPDU) according to a communication protocol that specifies a plurality of allowed lengths of a training field in a PHY preamble of the PPDU, and a plurality of allowed durations of a guard interval (GI) corresponding to a spacing between transmission symbols in the PPDU, including: when the network interface device determines that the PPDU is to use a first length of the training field and a first duration of the GI, generating a field of the PHY preamble to include a subfield set to a first value, the first value indicating that the PPDU uses the first length of the training field and the first duration of the GI. The one or more ICs are further configured to: when the network interface device determines that the PPDU is to use the first length of the training field and a second duration of the GI, generate the field of the PHY preamble to include the subfield set to the first value, and generate the field of the PHY preamble to include one or more other subfields set to one or more second values that correspond to a PHY mode that is not permitted by the communication protocol, wherein the subfield set to the first value and the one or more other subfields set to the one or more second values indicate that the PPDU uses the first length of the training field and the second duration of the GI. The one or more ICs are further configured to: generate the PHY preamble to include one or more training fields, each training field having the first length, and generate a data portion of the PHY data unit, wherein if the network interface device determined that the PPDU is to use the first duration of the GI, including GIs of the first duration between transmission symbols of i) the one or more training fields each having the first length and ii) the data portion, and if the network interface device determined that the PPDU is to use the second duration of the GI, including GIs of the second duration between transmission symbols of i) the one or more training fields each having the first length and ii) the data portion.

In other embodiments, the apparatus comprises one of, or any suitable combination of two or more of, the following features.

The subfield is a first subfield; the one or more other subfields includes i) a second subfield that indicates whether dual carrier modulation (DCM) is to be used for the PPDU, and ii) a third subfield that indicates whether space-time block coding (STBC) is to be used for the PPDU; the communication protocol does not permit both i) DCM to be used for the PPDU, and ii) STBC to be used for the PPDU; and generating the field of the PHY preamble to include one or more second subfields set to one or more second values that correspond to the PHY mode that is not permitted by the communication protocol includes: setting the second subfield to indicate that DCM is used for the PPDU, and setting the third subfield to indicate that STBC is used for the PPDU.

The first duration of the GI is 3.2 microseconds; and the second duration of the GI is 0.8 microseconds.

The length of the training field specified by the communication protocol is a first length; and the communication protocol specifies a second length of the training field, the second length being one fourth of the second length.

The network interface device comprises: a physical layer (PHY) processor implemented on the one or more ICs; and a medium access control (MAC) processors coupled to the PHY processor and implemented on the one or more ICs.

The PHY processor comprises: one or more transceivers.

The apparatus further comprises one or more antennas coupled to the one or more transceivers.

In yet another embodiment, a method is for processing a physical layer (PHY) protocol data unit (PPDU) received via a communication channel, the PPDU formatted according to a communication protocol that specifies a plurality of allowed lengths of a training field in a PHY preamble of the PPDU, and a plurality of allowed durations of a guard interval (GI) corresponding to a spacing between transmission symbols in the PPDU. The method includes: determining, at a communication device, that a subfield in a field of a PHY preamble of the PPDU is set to a first value, wherein the subfield is for indicating i) a length of each of one or more training fields in the PHY preamble, and ii) a duration of GIs for the PPDU; determining, at the communication device, the length of each of one or more training fields in the PHY preamble according to the first value of the subfield; determining, at the communication device, whether one or more other subfields in the field of the PHY preamble are set to one or more second values that correspond to a PHY mode that is not permitted by the communication protocol; when the communication device determines that i) the subfield is set to the first value, and ii) the one or more other subfields in the field of the PHY preamble are set to one or more second values that correspond to a PHY mode that is permitted by the communication protocol, determining, at the communication device, that the PPDU uses GIs of the first duration between transmission symbols; when the communication device determines that i) the subfield is set to the first value, and ii) the one or more other subfields in the field of the PHY preamble are set to one or more second values that correspond to the PHY mode that is not permitted by the communication protocol, determining, at the communication device, that the PPDU uses GIs of the second duration between transmission symbols; processing, at the communication device, the one or more training fields in the PHY preamble according to the determined length of each of the one or more training fields; and processing, at the communication device, a data portion of the PPDU according to the determined duration of the GIs.

In other embodiments, the method includes one of, or any suitable combination of two or more of, the following features.

The subfield is a first subfield; the one or more other subfields includes i) a second subfield that indicates whether dual carrier modulation (DCM) is used for the PPDU, and ii) a third subfield that indicates whether space-time block coding (STBC) is used for the PPDU; the communication protocol does not permit both i) DCM, and ii) STBC being used for a same PPDU; determining whether one or more other subfields in the field of the PHY preamble are set to one or more second values that correspond to a PHY mode that is not permitted by the communication protocol includes: determining whether both i) the second subfield is set to indicate that DCM is used for the PPDU, and ii) the third subfield is set to indicate that STBC is used for the PPDU; and when the communication device determines that i) the subfield is set to the first value, ii) the second subfield is set to indicate that DCM is used for the PPDU, and iii) the third subfield is set to indicate that STBC is used for the PPDU, the communication device determines that the PPDU uses GIs of the second duration between transmission symbols.

The first duration of the GI is 3.2 microseconds; and the second duration of the GI is 0.8 microseconds.

The length of the training field specified by the communication protocol is a first length; and the communication protocol specifies a second length of the training field, the second length being one fourth of the second length.

In still another embodiment, an apparatus, comprises a network interface device associated with a first communication device, wherein the network interface device includes one or more integrated circuits (ICs). The one or more ICs are configured to: process a physical layer (PHY) protocol data unit (PPDU) received via a communication channel, the PPDU formatted according to a communication protocol that specifies a plurality of allowed lengths of a training field in a PHY preamble of the PPDU, and a plurality of allowed durations of a guard interval (GI) corresponding to a spacing between transmission symbols in the PPDU, including: determining that a subfield in a field of a PHY preamble of the PPDU is set to a first value, wherein the subfield is for indicating i) a length of each of one or more training fields in the PHY preamble, and ii) a duration of GIs for the PPDU, determining the length of each of one or more training fields in the PHY preamble according to the first value of the subfield, and determining whether one or more other subfields in the field of the PHY preamble are set to one or more second values that correspond to a PHY mode that is not permitted by the communication protocol. The one or more ICs are further configured to: when the network interface device determines that i) the subfield is set to the first value, and ii) the one or more other subfields in the field of the PHY preamble are set to one or more second values that correspond to a PHY mode that is permitted by the communication protocol, determining that the PPDU uses GIs of the first duration between transmission symbols; and when the network interface device determines that i) the subfield is set to the first value, and ii) the one or more other subfields in the field of the PHY preamble are set to one or more second values that correspond to the PHY mode that is not permitted by the communication protocol, determining that the PPDU uses GIs of the second duration between transmission symbols. The one or more ICs are further configured to: process the one or more training fields in the PHY preamble according to the determined length of each of the one or more training fields; and process a data portion of the PPDU according to the determined duration of the GIs.

In other embodiments, the apparatus comprises one of, or any suitable combination of two or more of, the following features.

The subfield is a first subfield; the one or more other subfields includes i) a second subfield that indicates whether dual carrier modulation (DCM) is used for the PPDU, and ii) a third subfield that indicates whether space-time block coding (STBC) is used for the PPDU; the communication protocol does not permit both i) DCM, and ii) STBC being used for a same PPDU; the one or more ICs are configured to: determine whether both i) the second subfield is set to indicate that DCM is used for the PPDU, and ii) the third subfield is set to indicate that STBC is used for the PPDU, and when the network interface device determines that i) the subfield is set to the first value, ii) the second subfield is set to indicate that DCM is used for the PPDU, and iii) the third subfield is set to indicate that STBC is used for the PPDU, determine that the PPDU uses GIs of the second duration between transmission symbols.

The first duration of the GI is 3.2 microseconds; and the second duration of the GI is 0.8 microseconds.

The length of the training field specified by the communication protocol is a first length; and the communication protocol specifies a second length of the training field, the second length being one fourth of the second length.

The network interface device comprises: a physical layer (PHY) processor implemented on the one or more IC devices; and a medium access control (MAC) processor coupled to the PHY processor and implemented on the one or more IC devices.

The PHY processor comprises: one or more transceivers.

The apparatus further comprises one or more antennas coupled to the one or more transceivers.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method for generating a physical layer (PHY) protocol data unit (PPDU) according to a communication protocol that specifies a plurality of allowed lengths of a training field in a PHY preamble of the PPDU, and a plurality of allowed durations of a guard interval (GI) corresponding to a spacing between transmission symbols in the PPDU, the method comprising:
when a communication device determines that the PPDU is to use a first length of the training field and a first duration of the GI,
generating, at the communication device, a field of the PHY preamble to include a subfield set to a first value, the first value indicating that the PPDU uses the first length of the training field and the first duration of the GI;
when the communication device determines that the PPDU is to use the first length of the training field and a second duration of the GI,
generating, at the communication device, the field of the PHY preamble to include the subfield set to the first value, and
generating, at the communication device, the field of the PHY preamble to include one or more other subfields set to one or more second values that correspond to a PHY mode that is not permitted by the communication protocol,
wherein the subfield set to the first value and the one or more other subfields set to the one or more second values indicate that the PPDU uses the first length of the training field and the second duration of the GI;
generating, at the communication device, the PPDU, including:
generating the PHY preamble to include one or more training fields, each training field having the first length, and
generating a data portion of the PHY data unit, wherein
if the communication device determined that the PPDU is to use the first duration of the GI, including GIs of the first duration between transmission symbols of i) the one or more training fields each having the first length and ii) the data portion, and
if the communication device determined that the PPDU is to use the second duration of the GI, including GIs of the second duration between transmission symbols of i) the one or more training fields each having the first length and ii) the data portion.

2. The method of claim 1, wherein:
the subfield is a first subfield;
the one or more other subfields includes i) a second subfield that indicates whether dual carrier modulation (DCM) is to be used for the PPDU, and ii) a third subfield that indicates whether space-time block coding (STBC) is to be used for the PPDU;
the communication protocol does not permit both i) DCM to be used for the PPDU, and ii) STBC to be used for the PPDU; and
generating the field of the PHY preamble to include one or more second subfields set to one or more second values that correspond to the PHY mode that is not permitted by the communication protocol includes:
setting the second subfield to indicate that DCM is used for the PPDU, and
setting the third subfield to indicate that STBC is used for the PPDU.

3. The method of claim 1, wherein:
the first duration of the GI is 3.2 microseconds; and
the second duration of the GI is 0.8 microseconds.

4. The method of claim 3, wherein:
the length of the training field specified by the communication protocol is a first length; and
the communication protocol specifies a second length of the training field, the second length being one fourth of the second length.

5. An apparatus, comprising:
a network interface device associated with a first communication device, wherein the network interface device includes one or more integrated circuits (ICs) configured to:
generate a physical layer (PHY) protocol data unit (PPDU) according to a communication protocol that specifies a plurality of allowed lengths of a training field in a PHY preamble of the PPDU, and a plurality of allowed durations of a guard interval (GI) corresponding to a spacing between transmission symbols in the PPDU, including:
when the network interface device determines that the PPDU is to use a first length of the training field and a first duration of the GI, generating a field of the PHY preamble to include a subfield set to a first value, the first value indicating that the PPDU uses the first length of the training field and the first duration of the GI;
wherein the one or more ICs are further configured to:
when the network interface device determines that the PPDU is to use the first length of the training field and a second duration of the GI,
generate the field of the PHY preamble to include the subfield set to the first value, and
generate the field of the PHY preamble to include one or more other subfields set to one or more second values that correspond to a PHY mode that is not permitted by the communication protocol,
wherein the subfield set to the first value and the one or more other subfields set to the one or more second values indicate that the PPDU uses the first length of the training field and the second duration of the GI;
wherein the one or more ICs are further configured to:
generate the PHY preamble to include one or more training fields, each training field having the first length, and
generate a data portion of the PHY data unit, wherein
if the network interface device determined that the PPDU is to use the first duration of the GI, including GIs of the first duration between transmission symbols of i) the one or more training fields each having the first length and ii) the data portion, and
if the network interface device determined that the PPDU is to use the second duration of the GI, including GIs of the second duration between transmission symbols of i) the one or more training fields each having the first length and ii) the data portion.

6. The apparatus of claim 5, wherein:
the subfield is a first subfield;
the one or more other subfields includes i) a second subfield that indicates whether dual carrier modulation (DCM) is to be used for the PPDU, and ii) a third subfield that indicates whether space-time block coding (STBC) is to be used for the PPDU;
the communication protocol does not permit both i) DCM to be used for the PPDU, and ii) STBC to be used for the PPDU; and
generating the field of the PHY preamble to include one or more second subfields set to one or more second values that correspond to the PHY mode that is not permitted by the communication protocol includes:
setting the second subfield to indicate that DCM is used for the PPDU, and
setting the third subfield to indicate that STBC is used for the PPDU.

7. The apparatus of claim 5, wherein:
the first duration of the GI is 3.2 microseconds; and
the second duration of the GI is 0.8 microseconds.

8. The apparatus of claim 7, wherein:
the length of the training field specified by the communication protocol is a first length; and
the communication protocol specifies a second length of the training field, the second length being one fourth of the second length.

9. The apparatus of claim 5, wherein the network interface device comprises:
a physical layer (PHY) processor implemented on the one or more ICs; and
a medium access control (MAC) processors coupled to the PHY processor and implemented on the one or more ICs.

10. The apparatus of claim 5, wherein the PHY processor comprises:
one or more transceivers.

11. The apparatus of claim 10, further comprising:
one or more antennas coupled to the one or more transceivers.

12. A method for processing a physical layer (PHY) protocol data unit (PPDU) received via a communication channel, the PPDU formatted according to a communication protocol that specifies a plurality of allowed lengths of a training field in a PHY preamble of the PPDU, and a plurality of allowed durations of a guard interval (GI) corresponding to a spacing between transmission symbols in the PPDU, the method comprising:
determining, at a communication device, that a subfield in a field of a PHY preamble of the PPDU is set to a first value, wherein the subfield is for indicating i) a length of each of one or more training fields in the PHY preamble, and ii) a duration of GIs for the PPDU;
determining, at the communication device, the length of each of one or more training fields in the PHY preamble according to the first value of the subfield;
determining, at the communication device, whether one or more other subfields in the field of the PHY preamble are set to one or more second values that correspond to a PHY mode that is not permitted by the communication protocol;
when the communication device determines that i) the subfield is set to the first value, and ii) the one or more other subfields in the field of the PHY preamble are set to one or more second values that correspond to a PHY mode that is permitted by the communication protocol, determining, at the communication device, that the PPDU uses GIs of the first duration between transmission symbols;
when the communication device determines that i) the subfield is set to the first value, and ii) the one or more other subfields in the field of the PHY preamble are set to one or more second values that correspond to the PHY mode that is not permitted by the communication protocol, determining, at the communication device, that the PPDU uses GIs of the second duration between transmission symbols;
processing, at the communication device, the one or more training fields in the PHY preamble according to the determined length of each of the one or more training fields; and
processing, at the communication device, a data portion of the PPDU according to the determined duration of the GIs.

13. The method of claim 12, wherein:
the subfield is a first subfield;
the one or more other subfields includes i) a second subfield that indicates whether dual carrier modulation (DCM) is used for the PPDU, and ii) a third subfield that indicates whether space-time block coding (STBC) is used for the PPDU;
the communication protocol does not permit both i) DCM, and ii) STBC being used for a same PPDU;
determining whether one or more other subfields in the field of the PHY preamble are set to one or more second values that correspond to a PHY mode that is not permitted by the communication protocol includes:
determining whether both i) the second subfield is set to indicate that DCM is used for the PPDU, and ii) the third subfield is set to indicate that STBC is used for the PPDU; and
when the communication device determines that i) the subfield is set to the first value, ii) the second subfield is set to indicate that DCM is used for the PPDU, and iii) the third subfield is set to indicate that STBC is used for the PPDU, the communication device determines that the PPDU uses GIs of the second duration between transmission symbols.

14. The method of claim 12, wherein:
the first duration of the GI is 3.2 microseconds; and
the second duration of the GI is 0.8 microseconds.

15. The method of claim 14, wherein:
the length of the training field specified by the communication protocol is a first length; and
the communication protocol specifies a second length of the training field, the second length being one fourth of the second length.

16. An apparatus, comprising:
a network interface device associated with a first communication device, wherein the network interface device includes one or more integrated circuits (ICs) configured to:
process a physical layer (PHY) protocol data unit (PPDU) received via a communication channel, the PPDU formatted according to a communication protocol that specifies a plurality of allowed lengths of a training field in a PHY preamble of the PPDU, and a plurality of allowed durations of a guard interval (GI) corresponding to a spacing between transmission symbols in the PPDU, including:
determining that a subfield in a field of a PHY preamble of the PPDU is set to a first value, wherein the subfield is for indicating i) a length of each of one or more training fields in the PHY preamble, and ii) a duration of GIs for the PPDU,
determining the length of each of one or more training fields in the PHY preamble according to the first value of the subfield, and
determining whether one or more other subfields in the field of the PHY preamble are set to one or more second values that correspond to a PHY mode that is not permitted by the communication protocol;
wherein the one or more ICs are further configured to:
when the network interface device determines that i) the subfield is set to the first value, and ii) the one or more other subfields in the field of the PHY preamble are set to one or more second values that correspond to a PHY mode that is permitted by the communication protocol, determining that the PPDU uses GIs of the first duration between transmission symbols, and
when the network interface device determines that i) the subfield is set to the first value, and ii) the one or more other subfields in the field of the PHY preamble are set to one or more second values that correspond to the PHY mode that is not permitted by the communication protocol, determining that the PPDU uses GIs of the second duration between transmission symbols;
wherein the one or more ICs are further configured to:
process the one or more training fields in the PHY preamble according to the determined length of each of the one or more training fields, and
process a data portion of the PPDU according to the determined duration of the GIs.

17. The apparatus of claim 16, wherein:
the subfield is a first subfield;
the one or more other subfields includes i) a second subfield that indicates whether dual carrier modulation (DCM) is used for the PPDU, and ii) a third subfield that indicates whether space-time block coding (STBC) is used for the PPDU;
the communication protocol does not permit both i) DCM, and ii) STBC being used for a same PPDU;
the one or more ICs are configured to:
determine whether both i) the second subfield is set to indicate that DCM is used for the PPDU, and ii) the third subfield is set to indicate that STBC is used for the PPDU, and
when the network interface device determines that i) the subfield is set to the first value, ii) the second subfield is set to indicate that DCM is used for the PPDU, and iii) the third subfield is set to indicate that STBC is used for the PPDU, determine that the PPDU uses GIs of the second duration between transmission symbols.

18. The apparatus of claim 16, wherein:
the first duration of the GI is 3.2 microseconds; and
the second duration of the GI is 0.8 microseconds.

19. The apparatus of claim 18, wherein:
the length of the training field specified by the communication protocol is a first length; and
the communication protocol specifies a second length of the training field, the second length being one fourth of the second length.

20. The apparatus of claim 16, wherein the network interface device comprises:
a physical layer (PHY) processor implemented on the one or more IC devices; and
a medium access control (MAC) processor coupled to the PHY processor and implemented on the one or more IC devices.

21. The apparatus of claim 20, wherein the PHY processor comprises:
one or more transceivers.

22. The apparatus of claim 21, further comprising:
one or more antennas coupled to the one or more transceivers.
